(19) United States
(12) Patent Application Publication
(10) Pub. No.: US 2008/0109416 A1
(43) Pub. Date: May 8, 2008

(54) Method of searching and retrieving synonyms, similarities and other relevant information

(76) Inventor: Frank John Williams, Los Alamitos, CA (US)

Correspondence Address: Frank John Williams, 2711 Saint Albans Dr, Los Alamitos, CA, 90720, US

(21) Appl. No.: 11/983,076

(22) Filed: Nov. 6, 2007

Related U.S. Application Data
(60) Provisional application No. 60/857,016, filed on Nov. 6, 2006.

(51) Int. Cl. G06F 17/30

(52) U.S. Cl. 707/3

(57) ABSTRACT

A method and system for searching and retrieving associated information such as synonyms, antonyms, similarities, conclusive information, deductive information, suggestive information, and probable information, and phrases is described. In one embodiment, an initial query is “expanded” to include at least one said associated information, involving different types of querying information such as text, single identifiers, and/or group identifiers.

### RELATED APPLICATIONS

This is application claims the benefit of: provisional patent application Ser. No. 60/857,016 filed 2006 Nov. 6 by the present inventor.

### BACKGROUND

1. Field of the Invention

The present invention relates generally to retrieval of information in general. More particularly, a novel search system and methodology for generating results with identical or similar meanings, with or without the limitations of a particular text and/or language.

2. Description of Related Art

The revolution of the Internet is responsible for the evolution of many search engines used by millions of people to find what's important and relevant in their lives. However, current text-based technologies implement the text entered in the query to search, ignoring and evading equivalent, similar and/or relevant concepts identified through other forms of text such as synonyms, therefore finding only a portion or a fraction of all meaningful results. For example, if a user is looking to find issues relating to “pretty dogs,” he or she may type the text “pretty dog” in the query field. Accordingly, the search engine will find and provide only those sites or documents containing the actual text “pretty” and “dog,” yet omit other equally conceptual information such as sites or documents containing the text “beautiful k9” and/or “gorgeous canines.” Furthermore, distinctive, focused and largely detailed queries such as “pretty dogs with short tails and white fur” risk the retrieval of data, since a single text, such as “pretty” in instead of “beautiful,” will render the search engine incapable of retrieving said information using other forms of equally conceptual text. Another obstacle faced by textual searching is linguistic evolution. For example, in archaic documents a particular word was very common in its times; however, evolution has faded the word away and its concept is now described by a new word. Consequentially, it would be practically impossible for a modern speaker to find and/or retrieve the information. Furthermore, remarkable limitations are encountered when searching information across several languages, such as Europe, wherein closely neighboring geographic locations imply that searches for items in English, remove the possibility of finding the items in the neighboring France identified through French.

In view of the present shortcomings of implementing text to find information, the present invention distinguishes over the prior art by providing heretofore a broader and more compelling method of searching for information while providing additional unknown, unsolved and unrecognized advantages as described in the following summary.

### SUMMARY OF THE INVENTION

The present invention teaches certain benefits in use and construction which give rise to the objectives and advantages described below. The method and system embodied by the present invention overcome the limitations and shortcomings encountered by text-based searching by implementing a new expanded query format capable of retrieving all equally meaningful information from a single querying operation, thus permitting a superiorly robust search and retrieve methodology capable to handling more demanding and detailing queries for retrieving more relevant results.

### OBJECTS AND ADVANTAGES

A primary objective inherent in the above described method of use is to provide a searching and retrieving method not taught by the prior arts and further advantages and objectives not taught by the prior art. Accordingly, several objects and advantages of the invention are,

Another objective is to search and find similar and conceptually matching results from a single query.

Another objective is to allow searching of information of multiple languages from a single search entry.

Another objective is to find all pertaining and relating information.

Another objective is to find matching information regardless of the client linguistic skill and education.

A further objective is to decrease the time required for a client to find similar information.

A further objective is to permit large, detailed, and focused search queries.

A further objective is to reduce irrelevance by permitting more detailed queries.

A further objective is to permit searches of archaic information implementing modern language.

A further objective is to improve ecommerce.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 is a non-limiting block diagram of the most significant steps of the inventive method;

FIG. 2 is a non-limiting exemplary illustration of some steps of the inventive method depicted in FIG. 1;

FIG. 3 is a non-limiting illustration of a variation of the inventive method implementing several querying elements such as identifiers;

FIG. 4 is a non-limiting illustration of a further variation of the method depicted in FIG. 3 this time implementing single group identifiers in addition to other languages;

FIGS. 5A, 5B and 5C are non-limiting illustrations of the summaries of the exemplary disclosed methods depicted by FIG. 1, FIG. 2, FIG. 3, and FIG. 4;

FIG. 6 is a non-limiting illustration of a variation of the inventive method for selecting specific querying information from a group of information;

FIG. 7 is a non-limiting illustration of a further variation of the inventive method involving other associative type of querying information.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

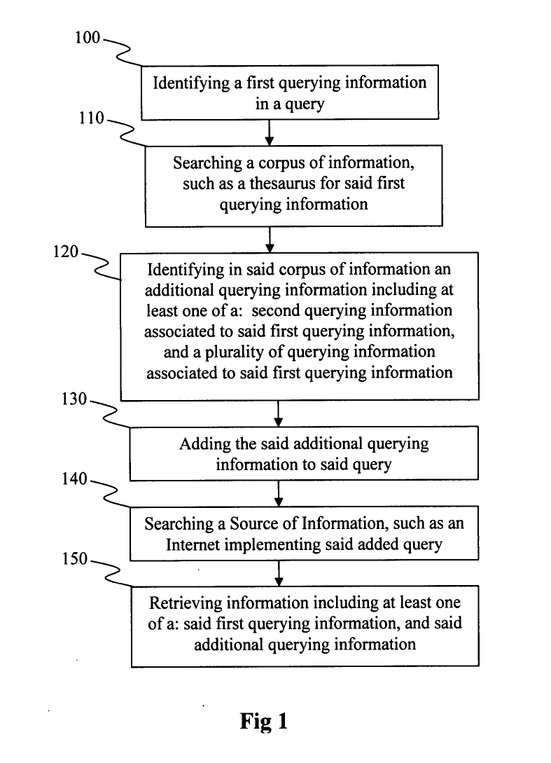

FIG. 1 is a non-limiting block diagram of the most significant steps of the inventive method. The First Step 100 (FIG. 1) involves identifying a first querying information in a query; wherein “querying information” is here introduced as any information that is used or can be used for searching and/or retrieving information. For example, identifying that a query comprises the word “dog” for searching the said “dog” word. The Second Step 110 (FIG. 1) involves searching for the said first querying information in a Corpus of Information such as a Thesaurus. For example, searching a thesaurus for the word “dog.” The Third Step 120 (FIG. 1) involves identifying or finding in said Corpus of Information (i.e., thesaurus, etc.) at least one other additional querying information associated to said first querying information, such as identifying another or several other information identifying a word or words. For example, identifying that the exemplary word “dog” is associated to one or several words such as synonyms like “k9,” “canine,” and/or “pooch.” The Fourth Step 130 (FIG. 1) involves expanding or adding the additional querying information (i.e., synonyms, antonyms, etc.) to the query. For example, it was found that the initial word “dog” had three more synonyms such as “k9,” “canine,” and “pooch.” As a consequence, the added query will now involve all the words such as “dog,” “k9,” “canine,” and “pooch.” The Fifth Step 140 (FIG. 1) involves the obvious step of searching a target Source of Information, such as an Internet for finding and retrieving information matching the said added or modified query. The Sixth Step 150 (FIG. 1) involves retrieving any records which comprise at least one of the querying information of the added query such as the first querying information or any other additional querying information. For example, the retrieval operation includes any records containing the word “dog” and/or “k9” and/or “canine” and/or “pooch.” In other words, results may include at least one word of the “dog” and its synonym group.

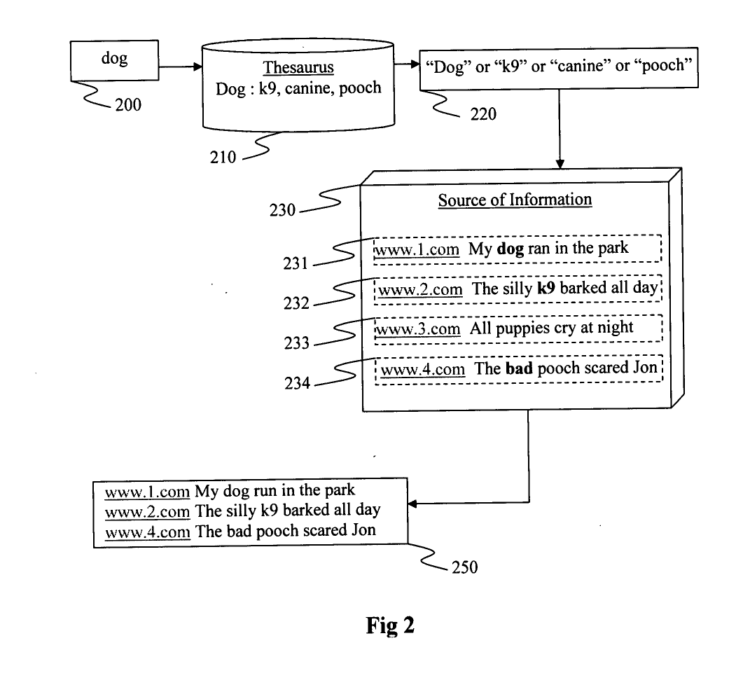

FIG. 2 is a non-limiting exemplary illustration of some steps of the inventive method depicted in FIG. 1. In FIG. 2, the Query Word 200 (FIG. 2) or “dog” is searched in the Thesaurus 210 (FIG. 2) which is identifying (or associating) other words such as k9, canine and pooch. As a result, the Expanded-OR-Query 220 (FIG. 2) now includes every single word (dog, k9, canine and pooch) separately or as groups. In others words, the expanded or added query is capable of retrieving any record comprising at least one word of the group. Accordingly, the search is executed upon the Source of Information 230 (FIG. 2) that contains a total of four exemplary websites. As illustrated the First website 231 (FIG. 2) contains the word “dog” thus matching at least one word or “querying information” of the Expanded-OR-Query 220 (FIG. 2). In similar fashion, the Second Website 232 (FIG. 2) and Fourth Website 234 (FIG. 2) all contain at least one word, thus said websites will all be retrieved. However, the Third Website 233 (FIG. 2) does not contain any words matching the Expanded-OR-Query. Consequentially, the said Third Website is not retrieved. The Results Display 250 (FIG. 2) illustrates the records (websites) that are distilled or retrieved from the Expanded-OR-Query (added query).

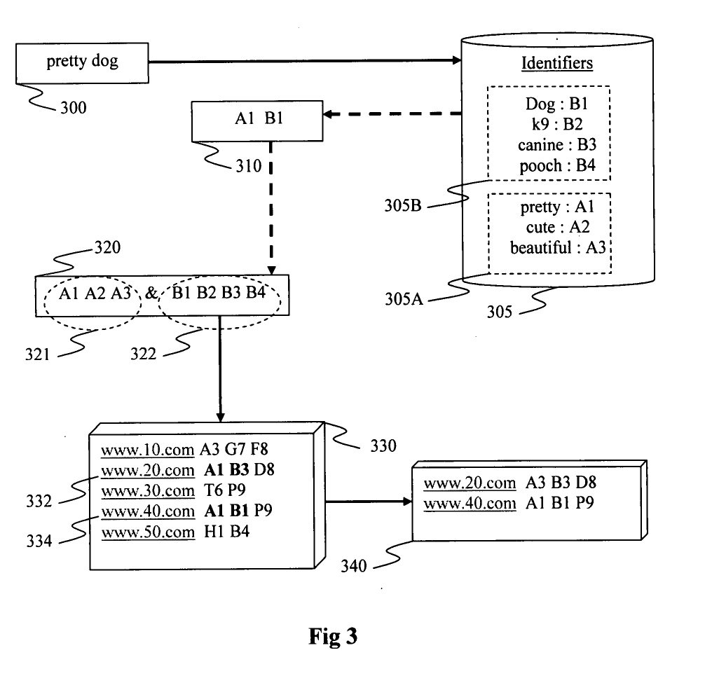

FIG. 3 is a non-limiting illustration of a variation of the inventive method this time substituting or replacing the initial query with a new query while implementing several querying elements such as using several languages and/or identities instead of words. The exemplary Initial Query 300 (FIG. 3) comprising two text elements, is converted or translated using the Identifier Database 305 (FIG. 3) to produce the new Converted Query 310 (FIG. 3) involving the substitution of the said text elements (“pretty” and “dog”) with their respective identifiers (“A1” and “B1”). Accordingly to the next step of disclosed inventive method, the Converted Query 310 (FIG. 3) is “expanded” into the new Expanded Query 320 (FIG. 3). Noteworthy, its also possible to create an expanded query directly from any initial query, but in order to fully illustrate and disclose the inventive method it has being chosen to separate the steps and/or graphics. As illustrated in the Identifier Database 305 (FIG. 3), all the synonyms (and/or others) of the word “dog” are identified in the B Group 305B (FIG. 3); while other elements such as synonyms of “pretty” are identified by the A Group 305A (FIG. 3). Consequentially, the new Expanded Query 320 (FIG. 3) contains two groups of querying information. The first Querying Group 321 (FIG. 3) is an “OR” type query or “OR” type search. In other words, prospective results must contain at least one “A” form querying elements (A1 or A2 or A3). In similar fashion. The Second Querying Group 322 (FIG. 3) is governed by the same “OR” rules. However, both querying groups obey a “AND” type query or “AND” type search. In other words, prospective results MUST have at least one element from the First Querying Group 321 (FIG. 3) AND also MUST have at least one element from the Second Querying Group 322 (FIG. 3). Better said, any “A” and any “B” becomes a result from the search. Accordingly, the search is executed upon the Source of Information 330 (FIG. 3) which contains five exemplary websites with their respective descriptions already in identifier language. Consequentially, according to the “OR” and “AND” ruling just described, only the Second Website 332 (FIG. 3)—www.20.com—and the Fourth Website 334 (FIG. 3)—www.40.com—comply with the said search and retrieving conditions of any “A” and any “B,” thus becoming results as illustrated by the Display Results 340 (FIG. 3).

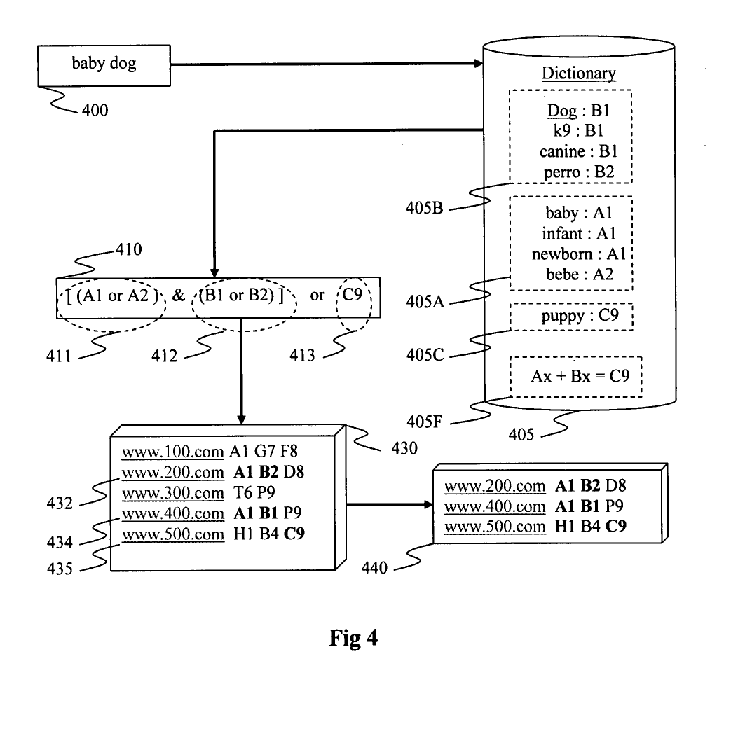

FIG. 4 is a non-limiting illustration of a further variation of the method depicted in FIG. 3 this time implementing single group identifiers, several languages, and grouping formulations. The Initial Query 400 (FIG. 4) is converted and/or translated into the New Converted Query 410 (FIG. 4) implementing the Dictionary 405 (FIG. 4). Please note, how according to the Dictionary 405 (FIG. 4), the First Word Group 405A (FIG. 4) groups and identifies the word “baby,” “infant,” and “newborn” with a single identifier (A1), and bebe (in Spanish) with a different identifier (A2). In similar fashion, the Second Word Group 405B (FIG. 4) identifies the English words of the animal (dog, canine, and pooch) through a single identifier (B1) and the Spanish word (perro) through a single identifier (B1). As a result, in similarity to what occurred in FIG. 3, the query is “expanded” to include all the elements of each group. In addition, the Dictionary 405 (FIG. 4) contains additional data such as the Third Word Group 405C (FIG. 4) identifying “puppy” which is a synonym to several word combinations, and the Identifier Formulation 405F (FIG. 4) which depicts the said word combination (Ax+Bx=C9) or: any “A” element in combination to any “B” element equals “C9.” Consequentially, the expanded query must also include the “C9.” In such fashion, the newly expanded or New Converted Query 410 (FIG. 4) involves the First Word Group AND the Second Word Group OR the Third Group, which in variables is: [{any A} AND {any B] OR {C9}. As illustrated, the Source of Information 430 (FIG. 4) contains five exemplary websites; wherein only the Second Website 432 (FIG. 4), the Fourth Website 434 (FIG. 4) and the Fifth Website 435 (FIG. 4) contain matching information, thus becoming retrieving records which are displayed as illustrated by the Display Results 440 (FIG. 4). Please note that the Fifth Website 435 (FIG. 4) was retrieved thanks to the “OR” function of the New Converted Query 410 (FIG. 4) allowing records which only comprise the “C9” information.

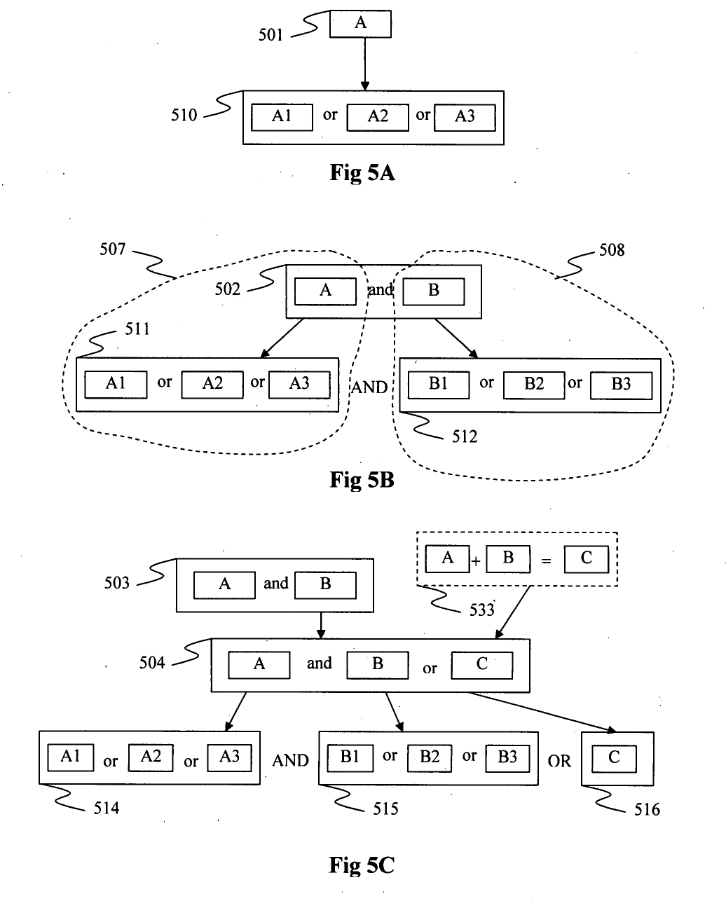

FIGS. 5A, 5B and 5C are non-limiting illustrations of the summaries of the exemplary disclosed methods in FIG. 1, FIG. 2, FIG. 3, and FIG. 4. In FIG. 5A, the Initial Single Element Query 501 (FIG. 5A) is expanded or converted into a Multiple Element “OR” Query 510 (FIG. 5A). In FIG. 5B, the initial query has this time two single elements which are joint by a “AND” type query (records containing only both elements—A and B—are retrieved). In similar fashion to FIG. 5A, each of the initial elements “A” and “B” are converted into their respective OR query (converted queries) comprising all their associated elements (synonyms, antonyms, similarities, etc.). For example, the conversion of the initial “A” element into its Expanded OR Query 511 (FIG. 5B) is delighted by the First Dashed Line 507 (FIG. A); while the expansion of the initial “B” element into its Expanded OR Query 512 (FIG. 5B) is delighted by the Second Dashed Line 508 (FIG. 5B). Finally, in FIG. 5C, the Formulation 533 (FIG. 5C) combines several querying elements present in the Initial Multiple Element Query 503 (FIG. 5C), thus resulting in a New Initial Multiple Element Query 504 (FIG. 5C). Accordingly, the New Initial Multiple Element Query 504 (FIG. 5C) is converted into their respective expanded OR queries still respecting the query format of the elements. As illustrated, the First Expanded Query 514 (FIG. 5C) is joined to the Second Expanded Query 515 (FIG. 5C) through a AND function; and both are joined the Third Expanded Query 516 (FIG. 5C) through an “OR” function. Please note, in this example, the Third Expanded Query 516 (FIG. 5C) or query due to the formulation 533 (FIG. 5C) comprises a single element (C). However, if such “C” element had associations, the associations will be included through another “OR” or expanded query, thus forming a query such as “[(any A) AND (any B)] or (any C).

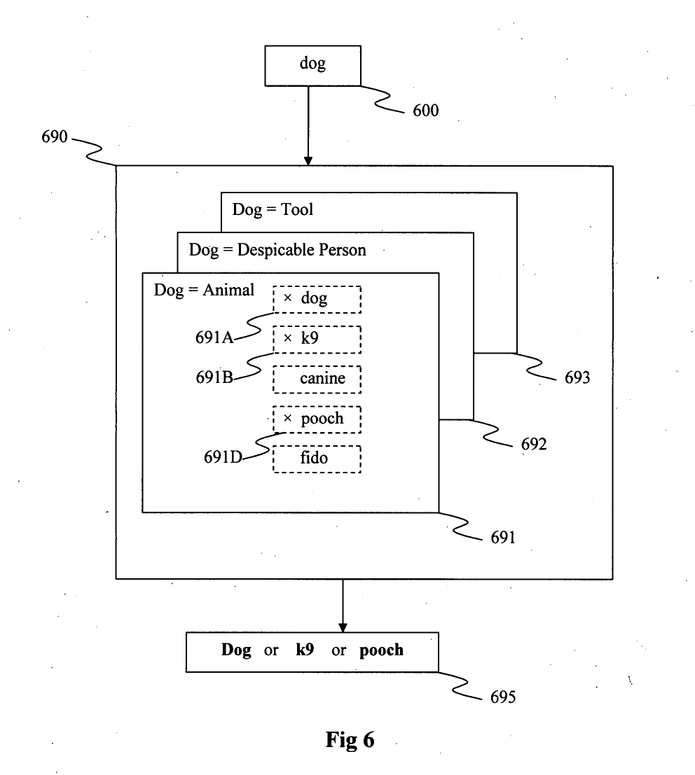

FIG. 6 is a non-limiting illustration of a variation of the inventive method implementing text for selecting specific querying information from a group of information, thus allowing a user to perform searches of specified data, such as choosing a smaller group of words within a bigger group. The First Word 600 (FIG. 6) is used to produce the Selecting Display 690 (FIG. 6) which comprises several groups of associated information to said First Word such as the First Tab Group 691 (FIG. 6) including synonyms of the animal meaning, the Second Tab Group 692 (FIG. 6) including synonyms of the tool meaning, and the Third Tab Group 693 (FIG. 6) involving synonyms of the despicable person meaning. In such fashion, selecting a particular Tab (or group), displays the synonyms of each meaning, allowing the user to further select each synonym or word for removing and/or adding it. Accordingly, in the First Tab Group 691 (FIG. 6), the selected words such as the First Synonym 691A (FIG. 6) or “dog,” the Second Synonym 691B (FIG. 6) or “k9,” and finally the Fourth Synonym 691D (FIG. 6), are implemented to create the Expanded OR Query 695 (FIG. 6) which comprises only the said chosen or selected words. Noteworthy, although the method described in FIG. 6 implements text, the same methodology can be used for implementing eeggi, with the difference of the added conversion step(s).

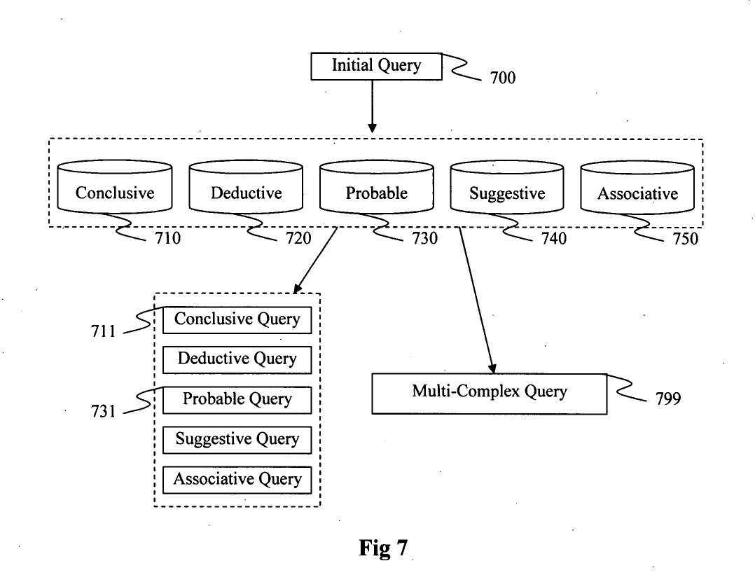

FIG. 7 is a non-limiting illustration of a further variation of the inventive method involving other types of associations for finding other information that is relevant to the querying information. The Initial Query 700 (FIG. 7) is search on several information associating type databases such as the Conclusive Database 710 (FIG. 7) associating elements such as “killed” with “dead,” the Deductive Database 720 (FIG. 7) associating information such as “broken” with “pain”, the Probable Database 730 (FIG. 7) associating information such as “dead” with “killed,” the Suggestive Database 740 (FIG. 7) associating information such as “birthday” with “gift”, the Associative Database 750 (FIG. 7) associating information such as “dog” with “fur” to name a few. In such fashion, a query like the Initial Query 700 (FIG. 7) can be expanded into several expanded queries such as the Conclusive Elements Query 711 (FIG. 7) and/or the Probable Elements Query 731 (FIG. 7); or possibly into a single Multi-Complex Query 799 (FIG. 7) which can comprise some or all the information from several associative type databases.

Noteworthy, other methods of searching methods, and/or additional querying elements and/or associations and their types add and modify the behavior of the methods without departing from the main spirit which is to “expand” a query.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method of searching and retrieving information can be appreciated. The described method overcomes the limitations encountered when searching and retrieving information implementing text by allowing the search and retrieval from a single search operation of other information such as synonyms, similarities, and other types of relevant or associated information that can satisfied the querying user.

1. A method for searching information such as synonyms, and similarities, the method comprising the steps of:
a) Identifying a first querying information in a query;
b) Identifying a N number of information associated to said first querying information; wherein N≧1;
c) Retrieving information including at least one of a: said first querying information, (N-M)th information; wherein M≦N and M assumes every integer value from M to zero;
d) Providing an information identifying at least one said retrieved information.

2. The method of claim 1, wherein said associated information involves a synonym.

3. The method from claim 1, wherein said associated information involve a similarity.

4. The method of claim 1, wherein said associated information involves a conclusive information.

5. The method of claim 1, wherein said associated information involves a deductive information.

6. The method of claim 1, wherein said associated information involves a information relating to said first querying information.

7. The method of claim 1, wherein said associated information involves a different language.

8. The method of claim 1, wherein said associated information involves a suggestive information.

9. The method of claim 1, wherein said associated information involves a probable information.
